(19) United States
(12) Patent Application Publication
(10) Pub. No.: US 2025/0109961 A1
(43) Pub. Date: Apr. 3, 2025

(54) EARLY WARNING ALERT FOR A DISTRACTED DRIVER

(71) Applicants: Demetrius THOMPSON, Beverly Hills, CA (US); Bertrand Russell SAKTHEES, Kodambakkam Chennai (IN)

(72) Inventors: Demetrius THOMPSON, Beverly Hills, CA (US); Bertrand Russell SAKTHEES, Kodambakkam Chennai (IN)

(21) Appl. No.: 18/834,542

(22) PCT Filed: Jan. 26, 2023
(86) PCT No.: PCT/US2023/011605

§ 371 Date: Jul. 30, 2024

Related U.S. Application Data
(60) Provisional application No. 63/305,186, filed on Jan. 31, 2022.
(60) Provisional application No. 63/419,971, filed on Oct. 27, 2022.

(51) Int. Cl. G01C 21/36; B60W 50/14

(52) U.S. Cl. CPC G01C 21/3679; B60W 50/14; G01C 21/3697; B60W 2050/143; B60W 2050/146; B60W 2555/60; B60W 2556/50

(57) ABSTRACT

One embodiment involves activating an alert in a vehicle when approaching a point of interest (POI) during a hands-free voice call. The vehicle's GPS location is compared to the latitude and longitude of selected POIs stored in a memory device, triggering an alert when within a predetermined distance. Another embodiment provides a system for vehicles to detect traffic light phase changes using an edge device to receive SPAT messages from the traffic light. An alert is issued based on the vehicle's position relative to the traffic light and the timing of the signal phase. In a third embodiment, a method for transferring GPS navigation system software uses an SDK to contact a server and load data, allowing different users to utilize the same SDK.

### CROSS-REFERENCE TO RELATED APPLICATIONS

This application claims the benefit of Provisional Patent Application No. 63/305,186, filed Jan. 31, 2022, and Provisional Patent Application No. 63/419,971, filed Oct. 27, 2022.

### FIELD OF THE INVENTION

The invention relates to a warning system to assist a driver to pay attention to road conditions.

### BACKGROUND OF THE INVENTION

In today's crowded driving space, distraction is a growing threat. Numerous studies have found that driver distraction can be a major factor in traffic accidents. The study “Distractions in Everyday Driving” by Jane Stutts 2003, et al, for AAA Foundation, quotes NHTSA studies that show driver distraction in up to 30% of police reported crashes, and calls out cell phone use, specifically, as one of the major distractions. Some drivers use hands free cell phone devices to mitigate this distraction, but a study found that the risk of having an accident increases fourfold while talking on a mobile phone and that using a hands-free phone is not any safer whether in the phone itself carried in a phone mount, or otherwise placed in receptacle in the vehicle, or when the phone is part of the vehicle's infotainment system—see: the study entitled “Role of mobile phones in motor vehicle crashes resulting in hospital attendance: a case-crossover study” by Suzanne P McEvoy (et. al), senior research fellow for the George Institute for International Health, University of Sydney, published 12 Jul. 2005 by the prestigious British Medical Journal.

A significant solution can be found U.S. Pat. Nos. 7,308,247 and 7,986,934, both titled “Cellular Telephone Safety System” and U.S. Pat. No. 9,568,334 titled “Safe Driving System Generating Map Points, each describing a system for detecting when a traffic signal is near. The systems detect when a wireless communication device is in an active voice mode and issues an alarm which can be used to warn that the traffic light is being approached. Such a system may or may not issue an alarm only when the traffic light is red or is calculated to be red by the time the vehicle reaches the intersection. Such a system can also be used to generate a warning when the vehicle is approaching a school zone or a railway crossing. The teachings of U.S. Pat. Nos. 7,308,247, 7,986,934, and 9,568,334, and the references cited therein are incorporated by reference herein. In the latter patent, vehicle GPS navigation systems and mobile GPS navigation systems display an icon of the traffic light on a map generated by the system. Such systems can display icons showing locations on the map of various other points of interest (POIs) chosen by the user, such as ATMs, restaurants, fire stations, police stations, emergency rooms, and the like.

### BRIEF SUMMARY OF THE INVENTION

The present application can be referred to as a distracted driver alert application (DDA Application”), which enhances the foregoing systems. One enhancement is the downloading of position data monolithically (e.g., all the data within a predetermined radius), so that the device will not be required to poll the data server continuously. In one embodiment of the invention, the DDA Application maintains a local cache/database of the locations of traffic lights, or other points of interest POIs on the device so that alerts can be generated immediately. The DDA Application can query the user to update the local cache/database of POIs each time the DDA Application starts up, or it can automatically request smaller incremental updates during operation. In another embodiment of the invention, information about a traffic signal is generated by the traffic light itself, or by a nearby signal generator. Information about the location of the traffic light (MAP data) is generated as well as information about the signal phasing and timing (SPAT), the former being static, the latter being dynamic. MAP and SPAT data can also be obtained from commercial or governmental sources. The technology of the DDA Application can save lives. The DDA Application can wirelessly communicate the signal phase and timing of a light and has a “Countdown to Green” voice warning.

In one embodiment, a software development kit (SDK) is provided in which data loading is isolated into an SDK—and only data loading is part of the SDK. Different users of the invention can all use the same SDK. Thus, the SDK will contact a server and load the point of interest (POI) data.

In another embodiment, country codes and information about latitude and longitude locations of the POIs are provided as string values.

In a further embodiment, the Driver Distraction Alert system comprises a roadside unit (RSU) processor (AI-500-085) that interfaces with the traffic signal controller by an edge device to receive SPAT messages. The RSU is located sufficiently close to the traffic light to be able to interface with it. An edge device comprises hardware that controls dataflow between two networks. The RSU processor transmits messages via the cellular network to the Server. The driver receives information via an application in their vehicle either directly over the cellular network or connected via Bluetooth. The system activates while on a hands-free voice call at traffic lights but can also be used to warn of school zones and railroad crossings.

The Driver Distraction Alert system is a collection of applications and services that automotive original equipment manufacturers (OEMs) can integrate into their in-vehicle infotainment systems. The system enables third-party developers to deliver Android applications to meet specific customer needs. In today's crowded driving space, distraction is a growing threat. The Driver Distraction Alert technology can save lives. The DDA Application can wirelessly communicate the signal phase and timing of a light and The DDA Application has a “Countdown to Green” voice warning.

### BRIEF DESCRIPTION OF THE DRAWINGS

For a more complete understanding of the present invention, reference is now made to the following descriptions taken in conjunction with the accompanying drawing, in which:

FIG. 1 is a user interface diagram of an embodiment of the system;

FIG. 2 is a flow chart showing the startup in an embodiment of the system;

FIG. 3 is a flow chart showing the steps in an alert generated by an embodiment of the system;

FIG. 4 is a diagram showing in an overlap of first and second rectangular (here, square) maps when data is requested when moving through the first map to the second map;

FIG. 5 is a diagram showing how a subscriber to the system obtains Map and SPAT data describing a series of messages that are part of what is commonly known as Cooperative Intelligent Transport Systems;

FIG. 6 depicts how an embodiment of the system encodes and decodes data using JavaScript Object Notation (JSON);

FIG. 7 depicts how an embodiment of the system decodes data from an autonomous system number identifier (ASN) library (ASn1C), using JSON, to a SPAT parser, asn1c being a free, open-source compiler of ASN.1 specifications into C source code and wherein an autonomous system number (ASN) is a globally unique identifier;

FIG. 8 is a flow chart describing SPAT flow of the system;

FIG. 9 is the code to generate a token id in an SDK functionality in an embodiment of the invention;

FIG. 10 is the code to get the POI file name for the traffic signal and railway crossing and school zone in North and South American;

FIG. 11 is the code to get the POI file name for the traffic signal and railway crossing and school zone except North and South American; and

FIG. 12 shows a module to generate Android Archive (AAR) files that can be included in any android project; and

### DETAILED DESCRIPTION OF THE INVENTION

Today's drivers are spending more time in their cars than ever before. They eat, talk on the phone, put on makeup, and do their hair, but when is it too much? As described in the Background of the Invention, numerous studies have found that driver distraction can be a major factor in traffic accidents and calls out cell phone use, specifically, as one of the major distractions. Some drivers use hands free cell phone devices to mitigate this distraction, but as previously indicated the risk of having an accident increases fourfold while talking on a mobile phone and that using a hands-free phone is not any safer.

Product Overview. The invention is a mobile alert system that uses a global positioning system (GPS) chip lodged inside cell phones, or in the automobile itself, to alert drivers that they are approaching a traffic light. This is accomplished by an early warning system designed to assist drivers engaged in a phone call to pay attention to road conditions. The system will alert the driver by playing a distinctive sound when the following conditions are met:
1) The DDA Application has been activated by the user.
2) a voice call is in progress (e.g., for mobile phones)—alternatively, in an embodiment, the system is always on.
3) the device is moving faster than a predefined velocity (e.g., 10 MPH)
4) the device is approaching a “point of interest” (POI)
5) The arrival time at the POI being approached is calculated to be within e.g., 150 meters.

The system uses location-based services on the above-mentioned chip—typically a combination of GPS enhanced with network augmentation to track the devices coordinates. Points of interest, which will generate an alert, may include stop lights, school zones, construction zones, traffic accident areas, etc. The sound is played on the output speaker currently in use, e.g., earpiece/speaker/headset/hands free kit. The DDA Application provides a minimal user interface to allow the user to enable/disable the DDA Application. If required, the user interface can display a “splash” screen that provides copyright information, and/or a legal disclaimer.

If the system requires explicit user permission to grant the DDA Application access to positioning data, the DDA Application also provides the user interface for this. If the device provides a standard user interface for this purpose, the DDA Application will use it. The DDA Application provides the ability for the user to download coordinate data monolithically so that the device will not be required to poll the data server continuously. For example, the data can be obtained within a radius of from 10 miles to 500-miles or more, Aside from the minimal user interface described above the DDA Application will run in the background and not be visible at all. The system relies on position data that is updated from a remote server and stored on the device, to maximize responsiveness. The system updates local data through an application programming interface (API) provided by the device operating system, or installed GPS interface.

Hardware Requirements. The hardware requirements for the system are:
(1) A mobile device capable of retrieving real-time geographical positional data (i.e., GPS positioning)
(2) A programmable device, which can run a background process.
(3) A device with the ability to simultaneously play an audio warning.
(4) For data updates the device should be able to retrieve data from an internet server.
(5) The device must be able to do these things during a voice call.

Architectural Overview. The system uses a client-server program. The client side of the system will run on the user's mobile device, or on the above-mentioned chip, to retrieve location information from the device operating system, retrieve point of interest data, and trigger alerts on the device according to the rules described above, in an event driven manner. Events are conditions that occur at unspecified, or asynchronous, times—such as reception of a GPS update, or reception of data from the remote server. Since a location-based application is naturally event driven, the DDA Application is designed to work in this manner.

The DDA Application will maintain a local cache/database of POIs on the device so that alerts can be generated immediately. The DDA Application can query the user to update the local cache/database of POIs each time the DDA Application starts up, or it can automatically request smaller incremental updates during operation if the device supports it. Since companies may charge the user to download data according to a data plan, and a data connection may not always be available, the DDA Application should support downloading a large chunk of data at one time to store locally. The user should also be able to configure the program to updated data automatically. The Server program will respond to positional requests from the client by sending the requested points of interest.

User Interface. The user interface of the DDA Application is that portion of the DDA Application which the users sees when they start the DDA Application, and with which they interact directly. The major functionality of the user interface is to allow the user to “activate” and “deactivate” the DDA Application and to update the local data store. After the DDA Application is initially activated, it will continue to run in “background mode” and restart automatically in background mode each time the device is restarted. The user will only need to run the user interface to modify their settings or deactivate the program.

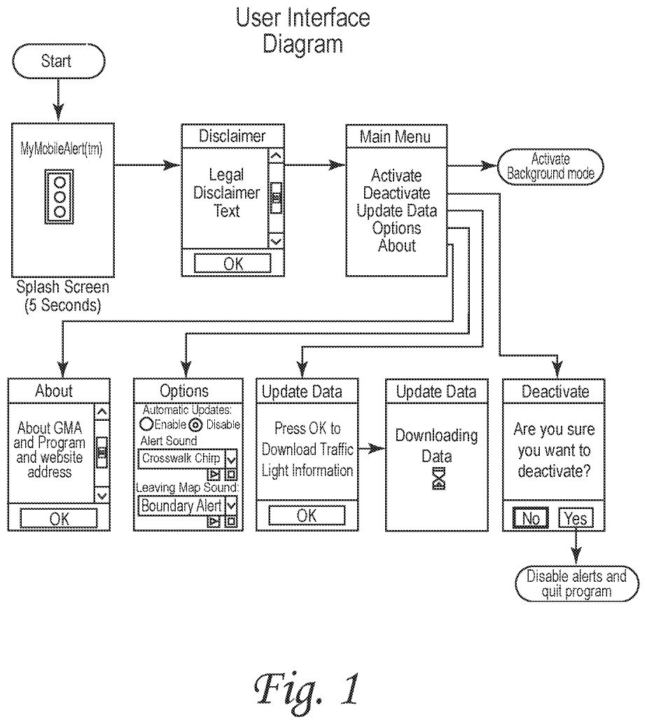

Splash Screen and Legal Disclaimer. FIG. 1 is a diagram of a user interface of an embodiment of the system. Following a brief display of a splash screen, the system displays a legal disclaimer which the user must accept to proceed. The disclaimer informs the user that ultimately it is their responsibility to drive safely and that limitations of the technology may cause the device to not play an alert when an alert would have been expected to play. This could happen because of not having a connection to the GPS satellites, not having the data of the POI in the database, interference with another program (i.e., contention for the GPS or audio resources), location outside of map boundaries, or failure to manually update data when automatic updates are disabled. It can also state that it is possible that even if the alert sounds, they may not hear it due to other distractions. The display of the legal disclaimer will have a scrollbar so that the user can view the entire text.

Main Menu. The main menu will provide the user with the ability to activate or deactivate the DDA Application, as well as updating the local data store, modifying the sound display options, and configuring the device for automatic updates or manual updates. When the DDA Application is “Active” alerts will be generated regardless of the user interface being visible or not. If the user chooses to “deactivate” the DDA Application, a confirmation dialog will first be displayed. If the users confirms the deactivation, an audio confirmation of deactivation will play, the “activate” menu option will be enabled, and the deactivate menu item will be grayed out.

Data Updates. Data updates are new POIs that become available after the current data set has been downloaded to the device (e.g., a new traffic light gets added within the current city) and supplement the existing local data. If the device is unable to download an update, alerts will continue to happen using the POIs already on the device. POIs are to be discarded only If the amount of data received would overflow the local storage. Ideally, data would be retrieved from a data server automatically; however, this may not always be possible for various reasons: the device may not be able to establish a data connection in some locations, platform certification requirements may require the user to authorize and enable data downloads, another application may be using the data connection (device specific), etc. Additionally, a data plan may charge the user to establish a data connection and an additional fee for the size of the download; consequently, on devices on which data can be dynamically downloaded, this option should be configurable by the user. The amount of data that gets downloaded may be limited by the configured size of the local data storage (e.g., a 1 MB data file). If the amount of data received would overflow the local storage, the points furthest from the device are discarded as new points are inserted. If the device leaves the current data boundaries, it can be configured to play a warning tone.

New local data should be provided in updates that occur several times per year, as POI data becomes available. It is recommended that data updates be built into the DDA Application and that the user downloads the update as an update to the entire DDA Application. This technique greatly simplifies the data update for the DDA Application by delegating the update processes to the device platform (i.e., manufacturer, operating system, and wireless carriers—e.g., Google Play Store, Apple App Store, Verizon VCast App Store, and the like). Users will automatically be notified of updates when a new version of the DDA Application is uploaded and will be able to download it when they update their DDA Applications—typically when they have a reliable connection.

Manual Updating. If the device is configured for Manual Updates (automatic updates disabled), the DDA Application will retrieve as much data as practical to store in the local storage. It can do this by requesting data from the server in a predetermined radius: e.g., 200 miles around current location. To update data, the device must be able to retrieve the device position, as well as connect to an internet data server. If it is not able to do these, it should display an error message with the option to “try again,” or cancel. An animation will play to show the user that data is being updated. If the amount of data that will be downloaded can be determined, the DDA Application should display a progress bar. If not, the DDA Application should display a looping animation—e.g., an animating hourglass.

Automatic Updating. In automatic mode, the DDA Application will request updates from the server as the device approaches the boundaries of the current local data—e.g., when the device is within 10 miles of current local data boundary.

Options. The options provided to the user are minimal. They will be able to enable automatic data updates and to select the sound for the audio alert—a female voice, a male voice, or a chirp (default). The user will be able to hear the currently selected alert sound by pressing a play sound button. The user will also be able to set the warning sound for when they are leaving the map boundary so that they will know not to expect any more alerts. The drop list will have an option called “<no sound>” in case the user does not wish to receive alerts for these options.

About. An “About” screen will display the DDA Application name, copyright, version information as required, and reference the company website.

Error Messages. To interfere with the user as little as possible error messages will only be displayed while the user interface is displayed—i.e., no error messages will be displayed by the background process.

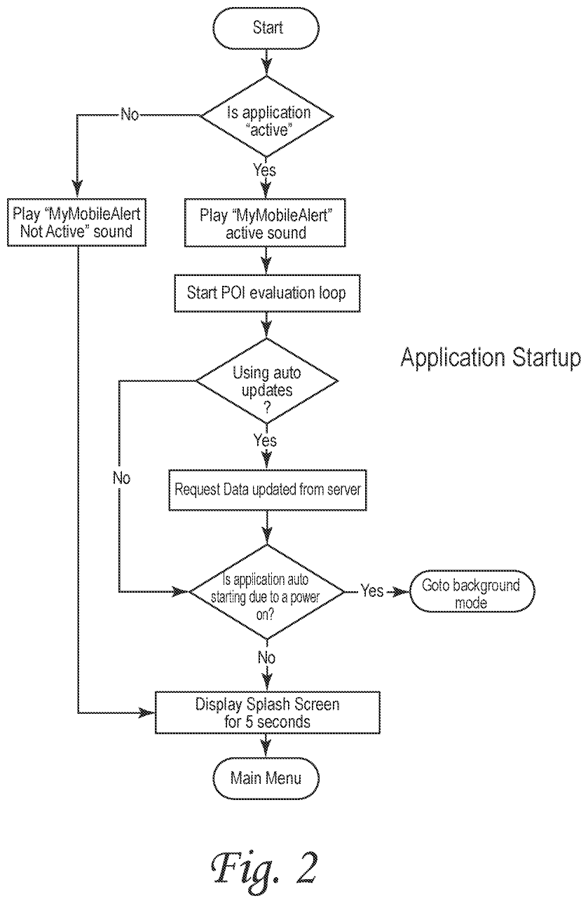

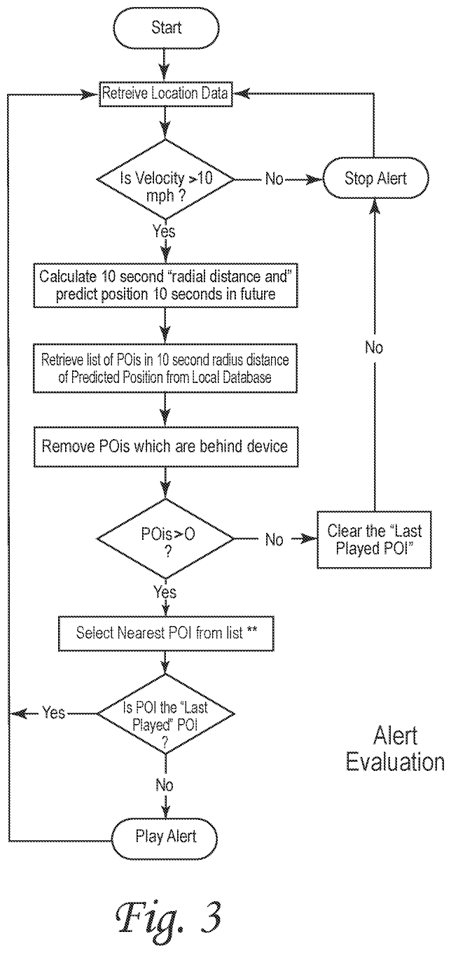

DDA Application Startup. Referring to FIGS. 2, 3 and 4, When the DDA Application starts up it will play an audible sound to indicate to the user whether the DDA Application is active. Once activated alerts will sound regardless of whether the user interface is visible. If the DDA Application was not started explicitly by the user, the DDA Application will go directly to background mode. Referring to the single asterisk in FIG. 3, removal of POIs which are behind the device is only necessary if database retrieval uses rectangular optimization. Referring to the double asterisk in FIG. 3, optionally, if the nearest POI is selected so that the appropriate sound type can be played for the type of POI, e.g., if a different sound is played for crosswalks or railroad crossings. If the DDA Application has been configured to automatically update data, it will send a server request out to retrieve updated POI data.

Main Background Processing Loop. The background processing loop is the evaluation routine that decides whether to play an alert. It should be reevaluated each time the position of the device changes. For devices that do not receive frequent GPS updates, the device can predict the position in between GPS updates. The “Last Played” POI is remembered each time that an alert is played to avoid repeatedly playing the alert for the same traffic light. Once the conditions that would cause the alert to be played for that light have changed, this information is cleared so that the alert can be replayed for that POI.

Event Processes. Events are conditions that occur at unspecified (or asynchronous) times. The DDA Application receives control of the device, handles the event, and then returns control of the device to the operating system—i.e., the DDA Application is designed as an event driven program. Typical events are reception of the location data in response to a previous position request, reception of POI data from the server, and timer interruptions that the DDA Application has requested. The Main Event handlers are the routines that executes whenever new POI data is received, or new GPS location data is received, or on a timer. Following is Pseudo Code for the main events received during operation of the program.

OnPOIDataReceived( ). This event handler is called when POI data is received from the server in response to a “get” data query. Reception of a new POI is inserted into both the local data and the in-memory data—called the ActivePOItree:

```
OnPOIDataReceived( )
{
  InsertNewDataIntoLocalDatabase( );
  InsertNewDataIntoActivePOITree( )
  RequestGPSPosition( );
  EvaluateIfShouldPlayAlert( );
}
```

OnGPSDataReceived. This event is called by the Operating System in response to a request for the GPS position of the local device. Depending on the API for the mobile device, a request for a GPS position may be delivered asynchronously. When the position is finally received, the program can “prune” the active POI tree, that is, it can discard POI data that is far enough away from the device that it is no longer relevant. This pruning will reduce the memory usage of the program. The program may also choose to prune the persistent data set based on a larger threshold.

OnGPSDataReceived( )
{
UpdatePositionVariables( )
PruneActivePOITree( );
EvaluateIfShouldPlayAlert( );
}

On Timer. The DDA Application should set the location change to ensure that the alert evaluation happens on a regular basis. The location depends on how reliable and regular the GPS notifications are from the local device. Please see the section on Calculations and Helper Functions below.

```
OnLocationChanged( )
{
  RequestGPSPositon( );
  PredictCurrentPosition( );
  EvaluateIfShouldPlayAlert( );
}
```

Client-Side Active POIs. The client will contain an in-memory data structure which contains POIs that are physically near the location of the device. POIs will be removed from the data structure when the distance to the device exceeds a defined distance (e.g., 10 miles). This distance can be altered dynamically if insufficient memory is available for the desired outer range distance.

As the device moves, it will request data updates for new POIs within a given distance of the device (e.g., 5 miles) from the Local POI database manager. The Local POI Manager maintains the local database which is persisted on the device file system. Additionally, the Local POI Manager will request data updates from a remote/internet server as required (see section on Server-Side Design) and as configured by the user (see section on Data Updates).

Both the local storage and the remote storage are optional, although at least one is required. This allows the device to be configured to use only local storage, only remote storage, or both. This design allows data to be preloaded (or downloaded through a data cable) on devices which do not support an internet connection. This also permits the software to work on devices which do not have any local persistent storage. Devices that store the data locally can also be updated with new data as it becomes available.

Triggering Conditions. For any point the trigger condition will be that the device is approaching the POI exceeding the threshold speed and that the device is calculated to reach the POI in less than a threshold time (e.g., speed>10 mph and ETA<10 seconds). Bool bPlayAlert=CurrentVelocity>VelocityTrigger && IsApproaching(NearestPOI) && TimeToPOI(NearestPOI)<TimeThreshold. When selecting the TargetPOI we will weed out POIs which are behind the device, that way we will stop playing sound after we pass a POI even if it is still the closest.

Playing the alert sound. When an alert is played, the POI that generated the alert should be recorded as well as the time the alert was played. When a request to play an alert is made, if the alert type is the same as the currently playing type, then the alert sound will not be interrupted.

To avoid replaying an alert multiple times for the same POI, the DDA Application should remember the last POI played until one of the following conditions occurs:
1) The POI is behind the device (e.g. the user has passed the traffic light).
2) A timeout for that POI has passed (e.g. 1 Minute)
3) The DDA Application restarts
   These conditions will allow the DDA Application to handle users that travel back and forth along routes that only have a single POI.

### User Notification Sounds.

Device approaching POI—beeping sound
Device in alert mode—voice notification
Device removed from alert mode—notification that will not be receiving further warnings.
Device leaving map boundaries—notification that will not be alerted
Device entering map boundaries—notification that will start playing alerts
DDA Application Started up—notification sound—may be a tune/beep/ or voice alert.

Client-Side POI Manager. Storage of the POIs on the client device will be logically divided into two portions: the “in memory” POIs, and the persistent storage (database). An application object called CPOIManager will keep track of all the POIs on the client device. It will cache a set of the nearest POIs used by the main DDA Application as well as manage the persistently stored POIs. It will automatically request new data from the server as the device reaches the current map boundaries (if so configured) and can purge POIs from the device when they exceed a specific distance.

The in-memory POIs set is essentially a cache of the nearest points. CPOIManager will organize the in-memory data using a Point Quadtree data structure. This will allow the Client DDA Application to quickly find the closest POIs in the tree. The in-memory footprint can be configured to contain a maximum number of entries. The furthest POIs in the QuadTree can be automatically removed as new data is inserted once the maximum is reached.

The POI data will be local persisted on the device in a data file. The data should be spatially organized and may utilize some form of compression—see the section entitled Local Database File Format below. The size of the local file store will also be configurable. This will allow the POI list to be read at startup time even if there is no internet connection to a remote server available. For devices which do not have internet connection, the client-side database will contain all the data available to the DDA Application. For additional coverage, the user will need to download additional map data.

Data Format. Latitude and Longitude are used as decimal degrees. For example, we will use 47.5° rather than 47 degrees, 30 minutes. The natural representation of this is a floating-point number. However, many mobile devices do not have floating point support, and so we can support the decimal degrees using fixed point number representation. To encapsulate for devices that don't support floating point, the data type will be called FLOAT32.

For fixed point representation, FLOAT32 will be encoded as 10.22 to allow+/−360 degrees to be encoded. In a 32-bit integer this means that 10 bits will encode the integer portion and 22 bits will encode the decimal portion. This will provide approximately 0.00000024 degrees of accuracy (1.0/(2\hat{ }22)). In Seattle (Latitude 47°):

1° of Latitude is approximately 111.325 Km*1000 m/Km*0.00000024=2.67 m

1° of Longitude is Approximately 1° of Latitude*Cos(Lat). ˜=2.67 m*cos(47°)=1.82 m.

When data is received from remote sources, it will be converted to FLOAT32 for application consistency.

Data Structures. The representation of data structures are generically presented as C structures, which are easily converted to the equivalent for platform specific programming. A Coordinate is a location on the globe and contains two elements. Lon=Longitude, and Lat=Latitude. Typically, a coordinate is called a Point and is abbreviated as “pt”

struct Coordinate
{
FLOAT32 lon, lat;
};

The list of active POIs will be stored in a dynamic “point quadtree” data structure. Each node in the data structure will contain four pointers: pNorthEast, pSouthEast, pSouthWest, and pNorthWest, as well as the type of the POI, so the appropriate alert sound can be played. The root node for the data structure may be stored in a global variable or as an DDA Application class member variable.

struct QNode
{
Coordinate pt;
ePOIType eType; // 8 bits
struct QNode* pNE; // points which are North East of this point
struct QNode* pSE; // points which are South East of this point
struct QNode* pSW; // points which are South West of this point
struct QNode* pNW; // points which are North West of this point
};

As GPS location updates are received. The DDA Application should store and update the current and previous positions and calculate the current velocity and acceleration. This will allow the program to predict the future position of the device—see section on Position Prediction below.

struct Position
{
Coordinate pt;
UINT32 timeReceived;
FLOAT32 velocity;
FLOAT32 acceleration;
};

The DDA Application should also keep track of the POI that activates an alert and at what time it has been played. This will be used when deciding whether to play an alert again.

struct AlertItem
{
Coordinate Position; // Lon, Lat of POI that triggered alert
ePOIType eType;
UINT32 timeActivated;};

As new nodes are received from the server, they will be inserted into the local quadtree. And nodes that exceed the outer range will be pruned from the tree to conserve memory. On insertion into a non-empty tree, the new point should be inserted at a random level in the tree, rotating the sub trees as required. At each level, the probability of inserting should be calculated as 1/n, where n is the number of items already in the tree. If inserting at a non-node level, a standard root insertion process, which rotates the tree, should be used. Note: that since the tree is a quadtree, the rotation must happen for two axis—the NE-SW axis, and the NW-SE Axis. This randomization tends to create a more balanced tree and protect against “worst case” insertion, i.e., when the data is inserted in a sequential order, without explicitly having to balance it.

Local Database File Format. Any GIS spatial file format may be used for local persistent storage. All that is required is that the client can read and write the file using random file access. Below are described a simple file format, and a more complex alternative.

Simple File Format. For local persistent storage, the simple file format used will be a serialization of the quadtree data structure. Immediately following the file header, there will be a file data node. All the information in the node will be identical to the data in the quadtree with exception that memory pointers will be replaced with Record indices. The file offset of the record can be calculated simply as:

```
    FilePos = FileHeader.OffsetData + index * sizeof(FileNodeRecord).
    Struct FileHeader
    {
    int MagicNumber; // used to help identify the file format e.g.,
    0xAD0G15DADA
  int SizeFileHeader; // size of this structure
  int NumRecords;
  int MaxRecords;
  int SizeOfRecord; // size of FileNodeRecord
  int FileOffsetRoot; // index of the quad tree root node
  int FileOffsetFreeList; // 0 if no free nodes available
  int OffsetData // start of data - used to convert index values to file
offsets
  }
```

Node records will not be deleted from the file, but rather just moved to the free list. This will allow fast insertions and deletions and a fixed size local data file. Once the free list is empty, inserting a new record will first delete the furthest POI from the current location and then reuse that location. Index 0 is reserved as an “invalid” index.

struct FileNodeRecord
{
FLOAT32 Lat, lon;
ePOIType eType; // 8 bits
bool bPersist; // should have lifetime?
int pNE; // Next node NE of this one (indexed)
int pSE; // Next node SE of this one (indexed)
int pSW; // Next node SW of this one (indexed)
int pNW; // Next node NW of this one (indexed)
};

The Free List will use the same structure, but only use pNE as the pointer to the next free index. Index 0 is reserved as an Invalid index—i.e., a NULL pointer.

R-Tree file format. A more efficient (and complex) data structure that is well suited to spatial access methods is the R-Tree. With an R-Tree, nearby POIs will be grouped and can thus save space in the file system. This data structure will also work well with updating data as the user device moves beyond existing map boundaries.

Since data for the entire world will be shipped with the DDA Application, the local database file format can be simplified. For example, each regional map file can have a single line that states the bounding rectangle, and the number of POIs of each type. E.g., the following example indicates that this map data file is bounded from −122.87809, 45.75770 upper left (NW) coordinate to lower right coordinate (SE) −104.99686, 39.74014, and contains 12000 type 0 (traffic signals), 112000 type 1 (school zones), and 15000 type 2 (Railroad crossings) POIs.
−122.87809, 45.75770, −104.99686, 39.74014, 12000, 11200, 15000
−122.87809, 45.75770
−122.66130, 45.58112
−122.41392, 45.50169
−122.68535, 45.52647
−122.41249, 45.51905
−122.56681, 45.47931
−122.77382, 45.58771
−122.69334, 45.58735
−122.69309, 45.55647
. . . .
   The map can be preprocessed into binary form such that the load can happen very quickly without having to parse the data. Additionally, the map files can be individually compressed to save space if required.

Map Boundaries. The client-side POI manager (CPOIManager) can keep track of the known data boundaries so that the client DDA Application will know if the user has crossed outside the map boundaries and can alert the user appropriately. If an internet connection is available and the user has enabled automatic data updates, CPOIManager will send queries out to the server requesting more data as the user approaches the map boundaries. Note, however, if all the world data is available on the server, it will not be necessary to handle updates from a server. The map boundaries can be preprocessed for optimal use by the POI Manager.

The POI Manager will have an index list of the individual regional maps, and their bounding areas. As the device moves, the local POI manager will be able to load the appropriate maps into memory. Each map should be loaded into its own Active POI quad tree such that the entire tree can be discarded when that region is no longer necessary. The maps should be sized such that at least two maps can be in memory at once.

struct MapBoundaries
{
Coordinate ptNW;
Coordinate ptSE;
POITree* pPOIQuadTree; // null if not currently loaded
};
MapBoundaries MapIndex [NUM_MAPS];

A query from the DDA Application to the local POI manager will return a result that includes the set of unique POIs from all the POI trees which contain the current point. If regions are not rectangular, regional bounding boxes could have significant overlap. If the amount of memory usage due to this is significant, the regions can easily be preprocessed into smaller sub regions with less overlap.

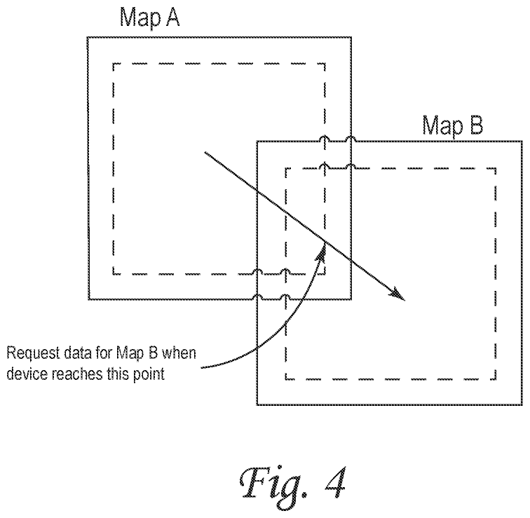

Referring to FIG. 4, In order to simplify processing, the POI manager will keep track of the current map data as occurring within a square. The size of the square should be as large as possible but will be limited by the amount of data the device can store. There will be a border width defined that is some size such that the DDA Application will have time to download new data before the device reaches the perimeter of the map. When data for the new region arrives, the POIs from the previous map that are not within the new map boundaries will be discarded.

In FIG. 4, the device/user is traveling South East. The current data set is called Map A. When the user reaches the border of Map A (dotted line), the device will request data for Map B. Then when data for Map B arrives, the device will discard data from map A that is not inside Map B.

Server-Side Design. The basic server-side DDA Application is a Webservice REST API which runs on a web server and will respond to queries for POI data from client DDA Applications by querying a database for POIs in a specified rectangle. The data in the database will be contained in a table with all the GPS coordinates for the traffic lights and other POIs as well as the type of POI (e.g., Traffic light, school crossing, railway crossing). A database with spatial support (or Spatial Extensions) which has spatial indexing should be used to optimize lookups.

An appropriate server(s) should be selected and hosted in a highly reliable data center. A backup server should also be run in a separate data center, and the client DDA Application should be configured to use the backup server when it is not able to contact the primary server. The IPs of the servers can be changed by modifying the DNS information for the web address of the server.

Server API. The server will respond to standard HTTP “get” requests. This allows the actual server implementation to use a standard server-side solution (e.g., PHP or Java scripting) and permits flexibility and ease of upgrading or changing the server-side solution.

The rectangle is specified by its central point, and by a radius, the radius will be specified with separate values for longitude and latitude. The radius will be specified in the same FLOAT32 degrees values (converted to ASCII) and must be positive (see section on Data Format). The URI provided to the “get” request will encode the location and radius. Data requests with rectangle boundaries which are out of range are returned a basic error message, or for increased security, no response at all. The server should also set a limit on the maximum rectangle size to avoid sending down too much data.

The resultant POIs will be returned in a packet which specifies, the number of POIs in the packet, and a bounding rectangle of all the points—specified using the North West and South East corners. It will then contain a series of data blocks that first state the type of the POI, and number of points followed by the actual data.

### Sample Returned Data Packet:

Data Header:
NumberOfPOIs=120
Bounding Rectangle=−122.3394,
47.6149, −122.3318, 47.5595
Type Of POI=Traffic lights,
NumberOfPOIs=100
Traffic light Ion, lat 1
Traffic light Ion, lat 2
...
Traffic light Ion, lat 100
Type of POI=School Crossing
NumberofPOIs=20
School Crossing Ion, lat 1
School Crossing Ion, lat 2
...
School Crossing Ion, lat 20

To reduce the data download size and time, which can also reduce user cost; it is recommended that the data be delivered as binary data that contains the coordinates already in FLOAT32 format. Sending in binary is more efficient than sending the data as text since generally the data size will be smaller and the client-side processing will be simpler. If doing this the MIME type can be set to “application/octet-stream”. If so required, the data can also be compressed if the client and server match compression schemes and the client has decompression software.

Ooen-Source Solutions. Various open-source solutions can be used to setup a custom data server—various configurations are presented below. However, with delegation of the data update to the device platform, a custom server is not required. The user interface can be simplified to remove any mention of a data updates.

Linux+Apache+MvSQL+PHP. This is a common open-source configuration commonly known as “LAMP”. It is well suited to high demand server-side applications. Additionally, many web hosting companies provide this as a standard hosted configuration. This would allow the solution provider to take advantage of the server hosting and maintenance by a third party. MySQL provides spatial functionality that is suited to supporting our POI data. The coordinates should be entered in the database as Point data which is of the Geometry class.

A REST API written in PHP will receive the request from the client DDA Application, look up the data in the MySQL database, format the data to be returned and return it via http. PHP can manipulate and return the data in binary form by setting the content type with the “header( )” function and then using the echo command to send the data:
Header(“Content-type: DDA Application/octet-stream”);
echo $data;

*nix+Apache+Resin+MySQL. A Java springboot based Webservice API can be designed which responds to queries from the client DDA Application and looks up the POIs in a MySQL database. The Java applet can use a ServletOutputStream to output the data in a binary format:
final ServletOutputStream out=res.getOutputStream( );
res.setContentType(application/octet-stream “ ”);
byte[ ]buf=new byte[bufsize];
// read data from database . . . and store in buf byte array
out. Write(buf, o, datalength);

*nix+ADache+PostareSQL+PostGIS+PHP. PostgreSQL DBMS is a powerful open-source relational database. PostGIS is also open source which “spatially enables” PostgreSQL by adding support for geographic objects, with the express purpose of allowing it to be a backend spatial database. PHP contains native support for PostgreSQL and thus provides a natural interface and is sited as “an excellent interface” by PostgreSQL. Any of the various *nixs (Linux, FreeBSD, etc) provide support for these programs.

Third Party Solutions. GPS data is available both as a separate product which can be installed directly by the customer or is available from a source called Open Street Data to which the customer's POI data can be overlaid and can serve as the backend of a POI server solution. OpenStreetMap is headquartered in Cambridge England, though they may seek new headquarters in Europe. The database is hosted by the OpenStreetMap Foundation, a non-profit organization registered in England and Wales and is funded mostly via donations. OpenStreetMap is freely licensed under the Open Database License.

POI Data, A key component of the DDA Application is the GPS location data for traffic lights and other POIs. Populating the server database is thus a key consideration.

Calculations and Helper Functions. Helper functions encapsulate common decision code. Explanations of calculations behind their implementation is provided below:
isApproaching(LonLat& POI, LonLat & CurPos, LonLat& Velocity)
isBehind(LonLat& POI, LonLat & CurPos, LonLat& Velocity)
DistanceInKm(LonLat & p1, LonLat & p2)
VelocityKmPH(LonLat & p1, LonLat & p2, FLOAT deltatime)
Distance(LonLatVector &Velocity, FLOAT time); // result in Kilometers
TimeToPOI(LonLat& POI, LonLat & CurPos, LonLat& Velocity);

Distance Calculations. Distances can be calculated using the spherical law of cosines:

$$d = arcos ( sin ( {lat}_{1} ) * sin ( {lat}_{2} ) + cos ( {lat}_{1} ) * cos ( {lat}_{2} ) * cos$$

$$( {Ion}_{2} - {Ion}_{1} ) ) * MeanRadiusOfEarth$$

If the device operating system does not provide trigonometric functions, or the trigonometric functions are expensive, then the DDA Application can maintain a lookup table to optimize the trigonometric function lookups.

Alternatively, distances can be calculated as:

$$dLat = ( p 2. lat - p 1. lat ) * LatitudeScalar ;$$

$$dLon = ( p 2. Ion - p 1. Ion ) * LongitudeScalar ;$$

$$d = Sqrt ( dLat * dLat + dLon * dLon ) ;$$

For “nearest point” calculations, d squared can be used so the square root does not need to be calculated. For consistency and ease of computation all distances are calculated in kilometers (km). To convert kilometers to miles, multiply by 0.6213712. To convert kilometers to nautical miles, multiply by 0.5399568.

Degrees to Distance Conversion (Scalars). A simplification for various calculations is to “flatten” the globe and treat Latitude and Longitude as a planar orthogonal coordinate system rather than use angular coordinates. This is a valid approximation when distances are short and the device is not near one of the poles. Since rings of latitude are constant, the latitude scalar is essentially constant:

$$LatitudeScalarKm = Circumference of Earth / 360 degrees \text{∼=} 40075$$

$$Km / 360 \text{∼=} 111.325 Km / degree .$$

Longitude varies based on latitude, and is easily calculated:

LongitudeScalarKm=cos(latitude)*LatitudeScalar

The longitude scalar can be recalculated occasionally.

Velocity Calculations. Typically, the velocity will be provided by the GPS system. If can also be determined by recording the received positions and the time differences of when they are received. The velocity is then calculated by the formula VelocityVector=dPos/dTime. That is the change in position divided by the elapsed time. For position prediction it is helpful to maintain the velocity as a vector with longitude and latitude components. These correspond to angular velocities. To convert these units to KmH, for our velocity threshold test, we use the formula:

$$K mPH = Sqrt ( {( Vel . Lat * LatitudeScalarKm )}^{∧} 2 + {( Vel . Ion * LongitudeScalarKm )}^{∧} 2 ) .$$

If we are just looking at the velocity to decide if we are moving fast enough, we can save the Sqrt calculation by using Velocity squared.

Bearing Calculation. The bearing (or heading) is the clockwise angle from North (East=90 degrees). Typically this will be provided by the GPS interface. If it is not, then the DDA Application can compare the new position to the previous position each time an update is received and calculate the current bearing using the formula:

$$θ = atan 2 ( sin ( dLon ) * cos ( lat 2 ) ,$$

$$cos ( lat 1 ) * sin ( lat 2 ) - sin ( lat 1 ) * cos ( lat 2 ) * cos ( ( dLon ) )$$

Where dLon=Ion2−Lon1.

IsBehind. The IsBehind function is used to Prune POIs which the device has already passed since the distance to them no longer matters. It can be simply evaluated using two different methods: 1) If the devices bearing (or heading) is known, calculate the bearing from the current position to the POI. If the absolute value of the difference between the bearings is greater than 90 degrees, then the POI is behind the device. See section titled Bearing Calculation above. 2) Generate a vector from the current location to the POI. Evaluate the dot product of this vector with the vector along the direction of travel, vecDirection. If the result is less than zero the point is behind:
VecDirection is usually in the same direction as VecVelocity, however, VecVelocity can be zero, while VecDirection should never be allowed to be zero:

$$VecDevice = VecDirection ;$$

$$VecPOI = PosPOI - PosDevice ;$$

$$IsBehind = ( VecPoi . Lon * VecDevice . Lon + VecPOI . Lat * VecPOI . lat ) < 0 ;$$

Position Prediction. Position Prediction is used for two things: 1) It is used to calculate the future position of the device so the DDA Application can retrieve POIs that are ahead of the device. 2) If updates from the GPS are not as frequent as required, the DDA Application can predict the current position on shorter intervals during timer events.

The DDA Application should utilize velocity and acceleration, to get the most accurate predictions. The latitude and longitude components will be calculated separately, so we can account for acceleration in each direction—e.g., acceleration in a curve.

Velocity and Acceleration can be calculated over short time intervals using just the known positions and the time at which the positions were received. Each time a positional update is received, the position and time are recorded. Only the difference in time from the previous positional update is required, so the DDA Application should use the highest precision time available—typically this is a system clock with millisecond resolution.

By recording the current and previous positions, the DDA Application can calculate the Current Velocity, by comparing the Current and Previous Velocity, the DDA Application can calculate the current average Acceleration:

### OnGPSPositionData( ):

$$PositionPrev = PositionCurrent ;$$

$$TimePrev = TimeCurrent ; *$$

$$DeltaTime = TimeCurrent - TimePrev ;$$

$$PositionNew = GPSPosition ;$$

$$VelocityNew = ( PositionNew - PositionPrev ) / DeltaTime ;$$

$$Acceleration = ( VelocityNew - VelocityPrev ) / DeltaTime ;$$

$$Distance = 1 / 2 acceleration * velocity * time$$

$$NewLon = PositionCurrent . Ion + Distance . Ion ;$$

$$NewLat = PositionCurrent . lat + Distance . lat ;$$

Zero delta time should be tested before calculating the new velocity and acceleration.

Local Data is important to the operation of the DDA Application. The Local Data stored on the device is recommended to be as large as will fit on the device. Currently, it is now practical to store data for most of the entire world on the device. Unreliability of data connections has been demonstrated to adversely affect the operation of the DDA Application, so the primary recommendation is that the DDA Application ship with the entire world POI data (compressed by region if necessary). This will also have the usability benefit that the DDA Application will be able to work immediately without a data update.

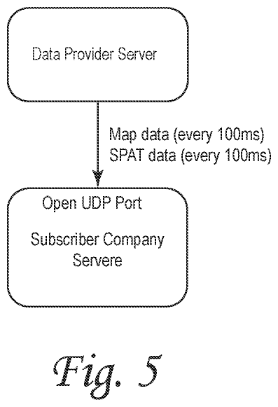

SPAT (Signal Process and Timing)—Introduction. Referring to FIG. 5, a series of messages are described that are part of what is commonly known as Cooperative Intelligent Transport Systems or CITS, which are a series of international standards available to all road authorities and vehicle manufacturers

There are 2 types of data that are used in transmission: 1) map data and 2) SPAT data. The standards for SPAT and map data are defined in a standard known as SAE J2735. Both map and SPAT messages are collected in traffic light intersections and are transmitted every 100 mS ( 1/10th of a second) to all vehicles through data providers. The data can be identified as being sent from a specific intersection.

Data Provider. Data providers are institutions that receive the map and the SPAT data from the traffic light intersections. These data providers in turn provide the data to companies that build automated car systems based on the map and the SPAT data. The data provider usually streams the data continuously to the companies that are subscribers that data.

This is done in the following way
1) The companies that subscribe to the provider setup a server.
2) The subscriber company opens a particular User Diagram Protocol (UDP) port number to receive the data. (The UDP is part of the Internet Protocol suite, referred to as UDP/IP suite and is a cooectionless protocol, sothere is no need to establish a connection prior to data transfer)
3) The provider sends map and SPAT data to the subscriber via a server port every 100 ms.

Server Implementation. In accordance with an embodiment of the invention, one can subscribe to the map and SPAT Data from a Data provider. One can setup an Amazon web cloud server and open a specific UDP port to receive map and SPAT data in Hex format.

Server Technologv. The server comprises of the following technologies:
Cloud Provider: Amazon web Services
Operating System: Linux
Web Server: Apache
Programming Languages
   1) Python Libraries (Pycrate)
   2) Python—Custom JSON Parser developed in Python
   3) C—Custom Parser developed in C for lane calculation
   4) PHP—
      RESTful webservices for consumption of Mobile App-addlocation.php
   5) Curl
      Cron Job to detect and restart the Python code for JSONparsing

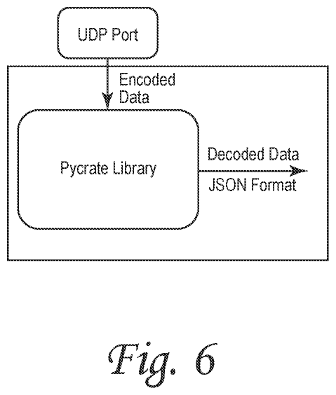

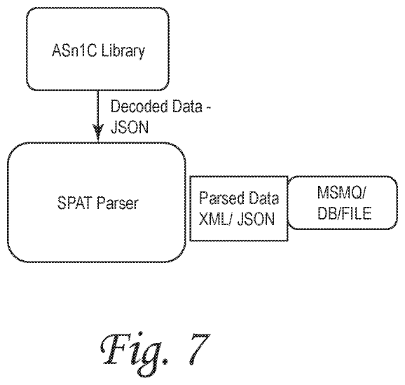

Conversion of Hex Data. FIGS. 6 and 7 depict how an embodiment of the system encodes and decodes data using JavaScript Object Notation (JSON). The system uses the Pycrate library to convert the hex data format to text data format. Pycrate is a Python library for manipulating various digital formats. It provides basically a runtime for encoding and decoding data structures, including CSN.1 and ASN.1 Additionally, it features a 3G and LTE mobile core network. The Pycrate library internally uses the SAE J2735 library to convert the Hex values to text values in JSON(JavaScript Object Notation) Format.

JSON Parser. The output of the Pycrate library is a JSON bases text file. The system uses a custom written parser to parse the relevant sections of the map and SPAT data. The map data is used to identify the intersections that are targeted for the technology proof of concept. The Parser then parses the SPAT data and forms a file called the “inputMAPSPaT.txt” file which has this string of the following format:
SPSSRSSXSRSSSRSSSPSSSSSXPSSSPSSSSRSSRSSS

For e.g., in the string above, the second character is a “P” which corresponds to a protected movement (green signal) for the Signal Group 2 which controls southbound through lanes.

depicts how an embodiment of the system decodes data from an autonomous system number identifier (ASN) library (ASn1C), using JSON, to a SPAT parser, asn1c being a free, open-source compiler of ASN.1 specifications into C source code and wherein an autonomous system number (ASN) is a globally unique identifier. The different states of the signal are represented as different letters:
unavailable=N
dark=D
stop-then=proceed=T
stop-and-remain=S
pre-movement=M
protected-movement-allowed=P
permissive-movement-allowed=R
protected-clearance=C
permitted clearance=E
caution-conflicting-traffic=L

Getting the Lat/Long Location. The server is set to subscribe to and receive the provider data once in 100 ms. However, the Server has no idea on the Latitude or the Longitude of the car. This is how the car's position is passed on to the server:
1) The Mobile App calls a webservice deployed on the server and passes on the Lat/long values of the Vehicle.
2) The Server receives the Lat/long values of the Vehicle and stores it in the “latlong.txt fie” in the same directory of the Parser.

Finding the lane information. The next step in the process is to find the lane information and the signal information. A custom parser that parses the output of the JSON Parser is stored in the “inputMAPSPaT.txt” file. This Parser can be written in C language and it reads the “inputMAPSPaT.txt” file, parses the string data and writes into the output file. This parser finds the following based on the 8 Character string written in the “inputMAPSPaT.txt” for a particular intersection. It finds the following:
1) Lane information
2) Signal information—Red/Green/Yellow
3) Direction Allowed—Straight, Left of Right
4) Count Down to Green Signal

The Output File is called as “outputMAPSPaT.txt”. The “outputMAPSPaT.txt” file consists of just 3 characters separated by a comma:
!) First Character—The Direction—Straight. Left of Right
(2 Second Character—The Signal—Red/Green/Yellow
3) Third Character—The “Count Down to Green” Alert

The “outputMAPSPaT.txt” file may look like “N, R, 0” or “S, Y, 1” or S, G, 0.

### First Parameter:

S—straight.
L—left.
R—right.

### Second Parameter:

R—red.
Y—yellow.
G—green.

### Third Parameter:

1-Countdown to Green—positive.

Cron Job. Cron is a utility program that lets users input commands for scheduling tasks repeatedly at a specific time. The Cron Job is written in CURL (standing for Client UR) and runs every 2 minutes. The Functions of the Cron Job are as follows:
1) Check if the JSON parser written in Python is running
2) Restart the JSON parser written in Python if it is NOT running.

The Cron Job ensures that the server parsing is continuous and is never stopped.

Deciphering the Output File and the Lat/Long Location. The next step in the process is to find the lane information and the signal information and the vehicle position. A parser that parses the output of the JSON Parser is stored in the “inputMAPSPaT.txt” file. It also parses the Latlong.txt file and based on the Lat/Long it calculates the Lane information. After calculation of the Lane information, the Parser moves ahead and reads the “inputMAPSPaT.txt” file and reads the 8-character string that corresponds to that traffic light. Based on the lane information and the 8-character string, the parser forms the output values and writes them to an outputMAPSPaT.txt” file.

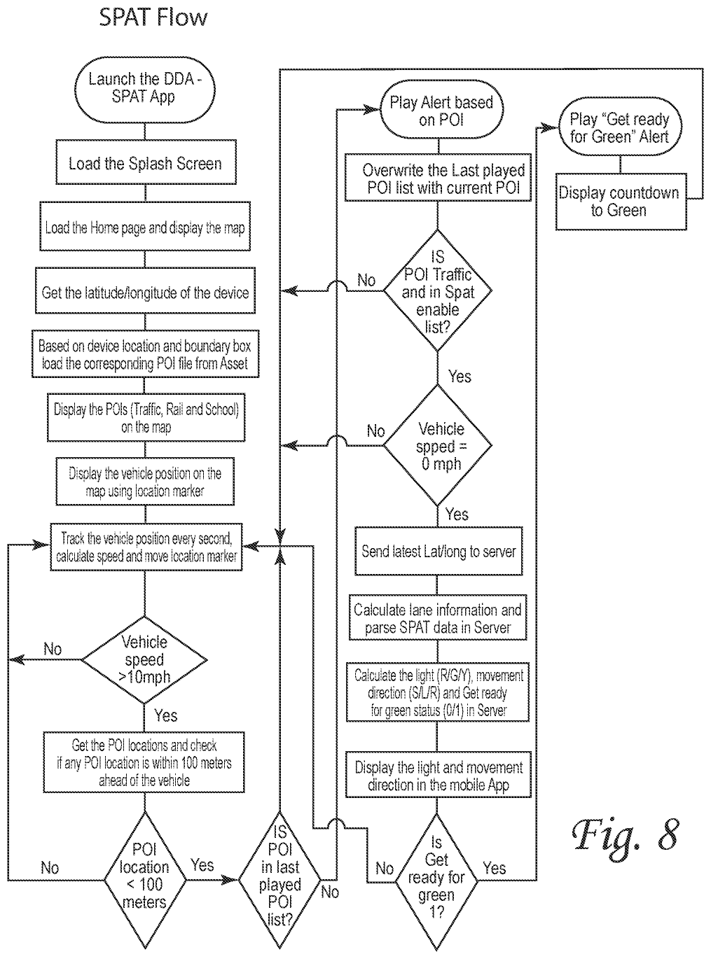

SPAT Flow. FIG. 8 is a flow chart describing the SPAT flow. The SPAT flow application, whether in the user's mobile device, or on the above-mentioned chip, functions to read and display data based on the map and SPAT data, following the following logic:
1) SPAT will continuously monitor the Lat/long of the mobile device (and hence the vehicle)
2) When the Vehicle is near any traffic Light the DDA Application checks alerts the user and sends the Traffic Light audio and visual alert
3) The DDA Application then checks if the speed of the vehicle is 0 Mph and if the Lat/Long position is among the traffic lights that the Data provider provides data.
4) If the speed of the vehicle is 0 Mph, and if the Lat/Long position is among the traffic lights that the Data provider provides data, the DDA Application understands that the vehicle is at a traffic light that has SPAT values streamed to the server.
5) The DDA Application sends the Lat/Long position to the server every second to the Addlocation.PHP webservice on the server
6) As discussed in the paragraph above, the Lat/Long position is stored in the “latlong.txt fie” in the same directory of the Parser by the Addlocation.PHP webservice.
7) The Addlocation.PHP webservice on the server then proceeds to call the Custom parser that get the lane information.
8) The custom parser than gets the Lane information, reads the 8-character strings in the “inputMAPSPaT.txt” file that correspond to the particular Lat/Long and based on the Lat/Long on the “latlong.txt fie” in the same directory of the Parser, it outputs the values in the “outputMAPSPaT.txt”
9) The addlocation.PHP webservice then reads the “outputMAPSPaT.txt” file and returns the values to the DDA Application.
10) The DDA Application then reads the output of the addlocation.PHP and based on the parameters, displays the Red/Green/Yellow lights.
11) The DDA Application continues to server webservice addlocation.PHP every second and display the latest traffic light information on the App.
12) If the third parameter of the “outputMAPSPaT.txt” file returns the value “1”, then the sever sends a voice alert “Countdown to Green” based on a “Countdown to Green” flag set in the server, and starts a countdown, usually sent 5-6 seconds before the light turns green to alert the driver to stop any distracting activities (like texting) and get back on focus.

SDK. In an embodiment of the invention, a software development kit (SDK) is provided to transfer software to a vehicle GPS navigation system wherein data loading is isolated into the SDK. Different users of the invention can all use the same SDK. Thus, the SDK will contact a server and load the point of interest (POI) data. In accordance with the invention, country codes and information about latitude and longitude locations of the POIs are provided as string values. The DDA Application uses the SDK for authentication, data loading, and alerts.

SDK Functionalities. More specifically, the SDK functions to authenticate the client, initialize and integrate an API, and make a POI class SFK in the following steps:
Get Country Code using current location latitude, longitude
Get Access Token
Get POI Files using latitude, longitude
Get POI Files using country codes

Flow of the DDA Application. The DDA Application:
1. Creates a map with setting options.
2. Calls the Authentication method of SDK.
3. Gets the current latitude/longitude of the Vehicle.
4. Provides current latitude/longitude to SDK and get traffic, school, and rail crossing files for that country/region.
5. Reads the data (latitude and longitude) from files received from the API through the SDK.
6. Gets latitude, longitude for traffic signal, rail crossing, school zone and show on map.
7. Calls SDK with current Lat/long every second and gets alert notification from SDK.
8. Shows the alert box with sound for traffic lights, railway crossings, and school zones.

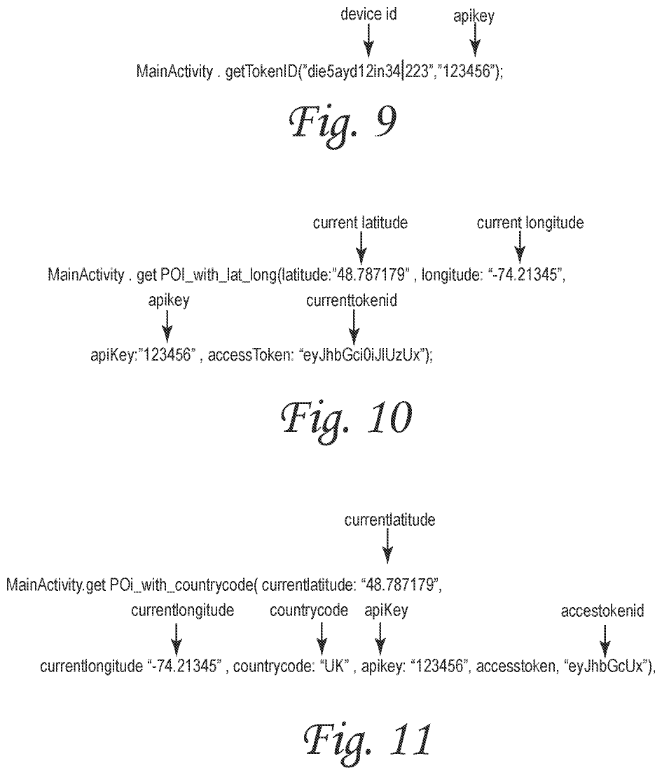

SDK Methods—Get Token ID. FIG. 9 is the code to generate a token Id. The token Id mainly used as a parameter while call other APIs from SDK methods. Put device id and api key as parameters. There are no return value while use this method. The device id and api key should be string values.

SDK Methods—GetPOI with Latitude and Longitude. This method is only for an American user. FIG. 10 is the code to get the POI file name for the traffic signal and railway crossing and school zone in North and South America. We need to pass latitude, longitude, and apiKey,accessToken parameters in this method which should be a string value. There are no return values in this method.

SDK Methods—GetPOI with country code. FIG. 11 is the code to get the POI file name for the traffic signal and railway crossing and school zone except North and South America. We need to pass latitude, longitude,countryCode,apiKey,accessToken in this method. Latitude,longitude,apiKey,accessToken parameter should be a string value. There are no return value while using this method.

SDK Methods—Get Current tokenid. Below is the code used to get current token id. There are no input parameters for this method. currenttokenid is the return value of this method. The return value is a string value.

Public static string getCurrenttokenid( ) {
return currenttokenid;
}

SDK Methods—GetPOIfile size. Below is the code to get the size of the POI files (example: some countries provide traffic file only, some countries provide traffic and school file path only, so we can get count of path files through this method). There are no input parameters for this method. The return value is an integer value.

public static string getPoifilesize( ) {
return poifilesize;
}

SDK Methods—GetFirstFile name. Below is the code to get the first POI file name. There are no input parameters for this method. fileone is the return value of this method. The return value is a string value.

public static String getFileone( ) {
return fileone;
}

SDK Methods—GetFirstFile Type. Below is the code to get the first POI file type (i.e., 1. Traffic light, 2. Schools, 3, railroad crossing). There are no input parameters for this method. fileonetype is the return value of this method. The return value is an integer value.

public static int getFileonetype( ) {
return fileonetype;
}

SDK Methods—GetSecondFile name. Below is the code to get the second POI file name. There are no input parameters for this method. Filetwo is the return value of this method. The return value is a string value.

public static int getFiletwo( ) {
return filetwo;
}

SDK Methods—GetSecondFile Type. Below is the code to get the second POI file type (i.e., 1. Traffic light, 2. Schools, 3, railroad crossing). There are no input parameters for this method. filetwotype is the return value of this method. The return value is an integer value.

public static int getFiletwotype( ) {
return filetwotype;
}

SDK Methods—GetThirdFile name. Below is the code to get the third POI file name. There are no input parameters for this method. filethree is the return value of this method. The return value is a string value.

public static int getFilethree( ) {
return filethree;
}

SDK Methods—GetThirdFile Type. Below is the code to get the third POI file type (i.e., 1. Traffic light, 2. Schools, 3, railroad crossing). There are no input parameters for this method. filetthreeype is the return value of this method. The return value is an integer value.

public static int getFiletwotype( ) {
return filethreetype;
}

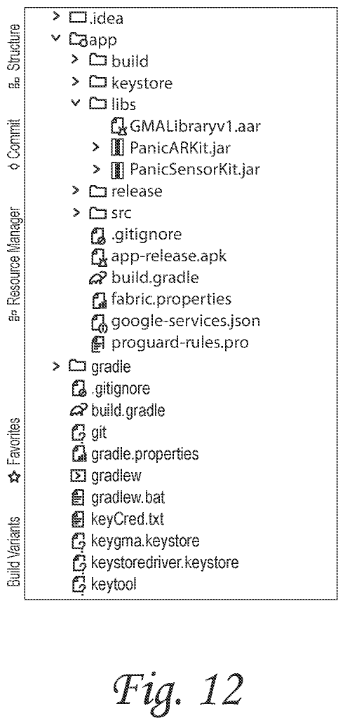

Libraryv1—Android Library. This module generates AAR files which can be included Any android project. FIG. 12 is an Android library used in an embodiment of this invention and shows menu items for a module to which to add AAR dependency.

1. A method for activating an alert in a vehicle when approaching a point of interest (POI) while on a hands-free voice call, comprising downloading to a memory device data comprising the latitude and longitude location of one or more selected POIs within a predetermined distance from the vehicle, determining the location of the vehicle from a navigation global positioning system (GPS), comparing the GPS location of the vehicle to data in the memory device and, when the vehicle is within a predetermined distance from the selected POI, activating the alert.

2. The method of claim 1 wherein to avoid replaying an alert multiple times for the same POI, the method includes remembering the last POI played until information is obtained that the POI is behind the device indicating that the user has passed the POI.

3. The method of claim 1 wherein the POI is selected from a traffic light, school zone, or railway crossing.

4. A system for a vehicle indicating a change in phase of a traffic light comprising providing information about the signal phase and timing (SPAT) of the traffic light generated by the traffic light or by a separate signal generator, the system comprising an edge device to receive SPAT messages from the traffic light or signal generator and to use information about the location of the vehicle relative the traffic light to issue to issue an alert when the timing of the signal phase indicates that the vehicle is either approaching the traffic light or is not moving at the traffic light, and that the phase of the traffic light will be changing within a predetermined time.

5. The system of claim 3 wherein the information about the SPAT is obtained from a roadside unit (RSU) processor that interfaces with the edge device.

6. The system of claim 3 including a server and wherein information about the SPAT from the RSU processor is saved to the server.

7. The system of claim 3 wherein the alert is a countdown to green.

8. A method for transferring software comprising a vehicle GPS navigation system to a server using a software development kit (SDK) wherein the SDK contacts the server to load data isolated in the SDK whereby different users of the GPS navigation.

9. The method of claim 7 wherein the SDK is used to authentication data loading, and alerts.
